(19) United States
(12) Patent Application Publication
(10) Pub. No.: US 2026/0302630 A1
(43) Pub. Date: Oct. 1, 2026

(54) CROSS-DIPOLE RADIATING ELEMENTS HAVING WIDE CLOAKING BANDWIDTHS

(71) Applicant: Outdoor Wireless Networks LLC, Richardson, TX (US)

(72) Inventors: Haifeng Li, Allen, TX (US); Peter J. Bisiules, LaGrange Park, IL (US)

(21) Appl. No.: 19/478,506

(22) PCT Filed: May 2, 2024
(86) PCT No.: PCT/US2024/027351

§ 371 Date: Oct. 24, 2025

Related U.S. Application Data
(60) Provisional application No. 63/463,928, filed on May 4, 2023.

(51) Int. Cl. H01Q 9/16

(52) U.S. Cl. CPC H01Q 9/16

(57) ABSTRACT

A radiating element comprises a feed stalk, a first dipole radiator that includes first and second dipole arms, and a second dipole radiator that includes third and fourth dipole arms. The first dipole arm comprises a base section, first and second side sections extending from the base section, and a distal section that electrically connects the first and second side sections. The base section and the first and second side sections each comprises a plurality of conductive patches that are interconnected by a plurality of meandered conductive traces. The distal section comprises a first additional meandered conductive trace that has a path length that is at least three times longer than an average of the path lengths of the meandered conductive traces that are included in the base section and the first and second side sections.

### CROSS-REFERENCE TO RELATED APPLICATION

The present application claims priority to U.S. Provisional Patent Application Ser. No. 63/463,928, filed May 4, 2023, the entire content of which is incorporated herein by reference.

### BACKGROUND

The present invention generally relates to radio communications and, more particularly, to base station antennas for cellular communications systems and to radiating elements for such base station antennas.

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with fixed and mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns of radiating elements or columns in which some of the radiating elements are staggered horizontally. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each linear array to simultaneously transmit and/or receive RF signals at two orthogonal polarizations.

Each of the above-described linear arrays is coupled to two ports of a radio (one port for each polarization). An RF signal that is to be transmitted by a linear array is passed from the radio port to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. The relative phases of the sub-components of the RF signal are set (e.g., using phase delay lines) so that the individual antenna beams generated by each subset of radiating elements constructively combine to narrow the half power beamwidth (“HPBW”) of the generated antenna beams in the elevation (vertical) plane. Since the above-described 2G/3G/4G linear arrays generate static antenna beams, they are often referred to as “passive” linear arrays.

Most cellular operators are currently upgrading their networks to support fifth generation (“5G”) cellular service. One important component of 5G cellular service is the use of so-called “active” beamforming arrays that operate in conjunction with active beamforming radios to dynamically adjust the size, shape and pointing direction of the antenna beams that are generated by the active beamforming array. These active beamforming arrays include multiple columns of radiating elements, with eight columns being the most common. Active beamforming arrays are typically formed using “high-band” radiating elements that operate in higher frequency bands, such as some or all of the 3.1-4.2 GHz and/or the 5.1-5.8 GHz frequency bands, although active beamforming arrays may also be provided that operate in other frequency bands such as the upper portion of the mid-band frequency range (e.g., 2300-2690 MHz). Each column of radiating elements of such an active beamforming array is typically coupled to a respective port of a beamforming radio.

The beamforming radio may be a separate device, or may be integrated with the active antenna array. The beamforming radio may dynamically adjust the amplitudes and phases of the sub-components of an RF signal that are fed to each port of the radio in order to generate antenna beams that have narrowed beamwidths in the azimuth plane (and hence higher antenna gain). These narrowed antenna beams can be electronically steered in the azimuth plane by proper selection of the amplitudes and phases of the sub-components of an RF signal.

In order to avoid having to increase the number of antennas at cell sites, the above-described 5G antennas often include passive linear arrays that support legacy 2G, 3G and/or 4G cellular services. In one popular solution, a 5G active antenna module (i.e., a module that includes an active beamforming array and associated beamforming radio) is mounted behind a passive base station antenna that includes a plurality of 2G, 3G, and/or 4G passive linear arrays. An opening is provided in the reflector of the passive base station antenna so that the antenna beams generated by the active beamforming array can be transmitted through the passive base station antenna. Typically, some of the radiating elements of the 2G/3G/4G passive linear arrays are mounted in front of the radiating elements of the beamforming array. The above-described antenna design is advantageous as the active antenna module may be removable, and hence as enhanced 5G capabilities are developed, a cellular operator may replace the original active antenna module with an upgraded active antenna module without having to replace the passive base station antenna. Herein, the combination of a passive base station antenna that has an active antenna module mounted thereon is referred to as a “passive/active antenna system.”

### SUMMARY

Pursuant to embodiments of the present invention, radiating elements are provided that include a feed stalk, a first dipole radiator that includes a first dipole arm and a second dipole arm, and a second dipole radiator that includes a third dipole arm and a fourth dipole arm. The first dipole arm comprises a base section, first and second side sections extending from the base section, and a distal section that electrically connects the first and second side sections. The base section and the first and second side sections each comprises a plurality of conductive patches that are interconnected by a plurality of meandered conductive traces. The distal section comprises a first additional meandered conductive trace that has a path length that is at least three times longer than an average of the path lengths of the meandered conductive traces that are included in the base section and the first and second side sections.

In some embodiments, an average width of the conductive patches that are included in the base section and the first and second side sections may be at least three times an average width of the meandered conductive traces that are included in the base section and the first and second side sections.

In some embodiments, the path length of the first additional meandered conductive trace may be at least five times longer than the average of the path lengths of the meandered conductive traces that are included in the base and first and second side sections.

In some embodiments, at least a portion of the first meandered conductive trace may have a wave structure. The wave structure may have at least four outer bends and four inner bends.

In some embodiments, the feed stalk may comprise a feed stalk printed circuit board that includes a first feed line for the first dipole radiator and a second feed line for the second dipole radiator.

In some embodiments, the first through fourth dipole arms may be configured to be substantially transparent to RF radiation in the 1.6-2.7 GHz frequency band and in the 3.4-4.0 GHz frequency band.

In some embodiments, the first additional meandered conductive trace may galvanically connect the first side section to the second side section so that the first dipole arm comprises a conductive loop.

In some embodiments, the first side section may include a second additional meandered conductive trace that has a path length that is at least twice as long as an average of the path lengths of the meandered conductive traces that are included in the base section, and the second side section may include a third additional meandered conductive trace that has a path length that is at least twice as long as the average of the path lengths of the meandered conductive traces that are included in the base section.

In some embodiments, the distal section may further comprise a second additional meandered conductive trace that has a path length that is at least three times longer than an average of the path lengths of the meandered conductive traces that are included in the base section and the first and second side sections.

In some embodiments, the distal section may further comprise a conductive patch that is interposed between the second additional meandered conductive trace and the third additional meandered conductive trace.

In some embodiments, the first dipole arm may further comprise a first transverse meandered conductive trace that connects the first side section to the second side section. A path length of the first transverse meandered conductive trace may be at least three times longer than the average of the path lengths of the meandered conductive traces that are included in the base section and the first and second side sections. In some embodiments, the first dipole arm may also further comprise a second transverse meandered conductive trace that connects the first side section to the second side section. In some embodiments, a path length of the second transverse meandered conductive trace may be at least three times longer than the average of the path lengths of the meandered conductive traces that are included in the base section and the first and second side sections. In some embodiments, at least a portion of the first transverse meandered conductive trace may have a wave structure. The wave structure may have at least four outer bends and four inner bends.

Pursuant to further embodiments of the present invention, radiating elements are provided that comprise a feed stalk, a first dipole radiator that includes a first dipole arm and a second dipole arm, and a second dipole radiator that includes a third dipole arm and a fourth dipole arm. The first dipole arm comprises a conductive loop and a first transverse meandered conductive trace that connects a first side section of the conductive loop to a second side section of the conductive loop, where the first transverse meandered conductive trace divides the conductive loop into an inner loop and an outer loop.

In some embodiments, the first dipole arm may further comprise a base section and a distal section, where the first and second side sections are positioned in between the base section and the distal section, and where the base section and the first and second side sections each comprises a plurality of conductive patches that are interconnected by a plurality of meandered conductive traces. In some embodiments, the distal section may comprise a first additional meandered conductive trace that has a path length that is at least three times longer than an average of the path lengths of the meandered conductive traces in the plurality of meandered conductive traces.

In some embodiments, a path length of the first transverse meandered conductive trace may be at least three times longer than the average of the path lengths of the meandered conductive traces in the plurality of meandered conductive traces. In some embodiments, an average width of the conductive patches may be at least three times an average width of the meandered conductive traces in the plurality of meandered conductive traces. In some embodiments, the path length of the first additional meandered conductive trace may be at least six times longer than the average of the path lengths of the meandered conductive traces in the plurality of meandered conductive traces.

In some embodiments, at least a portion of the first transverse meandered conductive trace may have a wave structure. The wave structure may have at least four outer bends and four inner bends.

In some embodiments, the first dipole arm may further comprise a second transverse meandered conductive trace that connects the first side section to the second side section.

Pursuant to additional embodiments of the present invention, radiating elements are provided that comprise a feed stalk, a first dipole radiator that includes a first dipole arm and a second dipole arm, and a second dipole radiator that includes a third dipole arm and a fourth dipole arm. The first dipole arm comprises a conductive loop that comprises a plurality of conductive patches that are interconnected by a plurality of meandered conductive traces. A first meandered conductive trace in the plurality of meandered conductive traces has a width that is at least three times less than an average of the widths of the conductive patches and a path length that is at least three times longer than an average of the path lengths of the conductive patches.

In some embodiments, a base of the first dipole arm may be adjacent a base of the second dipole arm, and the first narrowed meandered conductive trace may be positioned at a distal end of the first dipole arm.

In some embodiments, a second meandered conductive trace in the plurality of meandered conductive traces may have a width that is at least three times less than the average of the widths of the conductive patches and a path length that is at least three times longer than the average of the path lengths of the conductive patches.

In some embodiments, at least half of the meandered conductive traces in the plurality of meandered conductive traces may have respective widths that are at least three times less than the average of the widths of the conductive patches and respective path lengths that are at least three times longer than the average of the path lengths of the conductive patches

Pursuant to still further embodiments of the present invention, radiating elements are provided that comprise a feed stalk and a first dipole arm that comprises a base section, first and second side sections extending from the base section, a first distal section that extends from a distal end of the first side section and includes a first plurality of fingers and a second distal section that extends from a distal end of the second side section and includes a second plurality of fingers. The first plurality of fingers are interdigitated with the second plurality of fingers.

In some embodiments, the first and second plurality of fingers may form an interdigitated finger capacitor.

In some embodiments, the first distal section may further comprise a metal trace that galvanically connects the first distal section to the second distal section.

In some embodiments, the base section and the first and second side sections may each comprise a plurality of conductive patches that are interconnected by a plurality of meandered conductive traces.

### BRIEF DESCRIPTION OF THE DRAWINGS

FIG. 1A is a schematic perspective view of a conventional low-band cross-dipole radiating element.

FIG. 1B is a schematic side view of the conventional low-band cross-dipole radiating element of FIG. 1A.

FIG. 2A is a schematic perspective view of a passive/active antenna system that includes a passive base station antenna that may be implemented using low-band radiating elements according to embodiments of the present invention.

FIG. 2B is a schematic front view of the passive/active antenna system of FIG. 2A with the radomes thereof omitted.

FIG. 3A is a schematic plan view of a dipole radiator printed circuit board of a radiating element according to embodiments of the present invention.

FIG. 3B is a comparative diagram illustrating the current distribution on the dipole radiators of the conventional radiating element of FIGS. 1A-1B as compared to the current distribution on the dipole radiators of the radiating element according to embodiments of the present invention of FIG. 3A.

FIG. 3C is a plan view of the dipole radiator printed circuit board of a modified version of the radiating element of FIG. 3A.

FIGS. 4-13 are schematic plan views of dipole radiator printed circuit boards of radiating elements according to further embodiments of the present invention.

FIG. 14 is a schematic plan view of a meandered conductive trace in the form of a spiral inductor that may be used in the radiating elements according to further embodiments of the present invention.

### DETAILED DESCRIPTION

The above-described passive/active antenna systems allow a cellular operator to support both legacy 2G/3G/4G cellular service and 5G cellular service using a single base station antenna system. Unfortunately, however, in practice the radiating elements of the passive 2G/3G/4G arrays that are mounted in front of the 5G beamforming array can cause “scattering” of the antenna beams generated by the 5G beamforming array. Scattering is undesirable as it may reduce the gain of the 5G antenna beams by changing the shape thereof in both the azimuth and elevation planes. For example, scattering tends to negatively impact the beamwidth, beam shape, pointing angle, gain and front-to-back ratio of the 5G antenna beams.

Two different types of scattering can occur. First, conductive structures of the radiating elements of the lower frequency (passive) arrays that are mounted in front of the 5G beamforming array can reflect RF energy transmitted by the radiating elements of the beamforming array. Some of this reflected RF energy may then exit the base station antenna in undesired directions (potentially after further reflecting off of other metal structures in the base station antenna such as the reflector, etc.) or may exit the base station antenna in a desired direction but with a phase that causes the reflected RF energy to destructively combine with non-reflected RF energy. The net result is that when RF energy emitted by the beamforming array reflects off the radiating elements of the passive 2G/3G/4G linear arrays, these reflections generally act to distort the radiation pattern generated by the beamforming array in undesirable ways.

The second type of scattering occurs when a conductive structure of the radiating elements of the passive 2G/3G/4G linear arrays has an electrical length that makes the structure resonant in the operating frequency band of the 5G beamforming array. A conductive structure of a radiating element of one of the passive (lower frequency band) arrays may be resonant in the operating frequency band of the 5G (higher frequency band) beamforming array if, for example, the conductive structure has an electrical length that is about ½ a wavelength or about a full wavelength of a frequency within the operating frequency band of the 5G beamforming array. In many cases, the operating frequency band of the beamforming array may be about four times frequencies within the operating frequency band of the passive low-band linear arrays and about twice frequencies within the operating frequency band of the passive mid-band linear arrays. Since, for example, the dipole arms of the radiating elements of the low-band linear arrays typically have an electrical length of about ¼ of a center wavelength of the low-band operating frequency range, they may have a resonant length with respect to RF energy emitted by the 5G beamforming array. As such, RF energy transmitted by the 5G beamforming array may couple to, for example, the dipole arms of nearby low-band radiating elements, and the higher-band currents formed on these dipole arms generates additional high-band radiation that distorts the high-band antenna beams (since some of the RF energy is being emitted from unintended locations, namely from the low-band dipole arms).

So-called “cloaking” radiating elements are known in the art that have dipole arms that are designed so that currents will largely not form thereon in response to RF radiation in pre-selected frequency ranges (e.g., currents in the operating frequency band of the high-band radiating elements in the 5G beamforming array). These radiating elements can reduce or eliminate the second of the above-described types of scattering of higher frequency band radiation by the dipole arms of nearby lower frequency band radiating elements.

Pursuant to embodiments of the present invention, base station antennas are provided that include low-band radiating elements that have cloaked dipole arms that may have reduced impact on nearby arrays of mid-band and high-band radiating elements. These low-band radiating elements may have very high levels of transparency with respect to high-band RF radiation, and may also have high levels of transparency with respect to mid-band radiation. The dipole arms of the radiating elements according to embodiments of the present invention may have increased inductance as compared to conventional cloaking low-band radiating elements. This increased inductance may act to reduce the formation of high-band currents on the dipole arms in response to high-band RF radiation. The high inductance may ensure that the radiating elements are highly cloaked with respect to high-band RF radiation, and substantially prevents high-band RF currents from forming on the dipole arms of the low-band radiating elements.

In some embodiments, the dipole arms of the low-band radiating elements according to embodiments of the present invention may comprise a plurality of relatively wide conductive patches that are interconnected by a plurality of relatively narrow meandered conductive traces. Herein, a meandered conductive trace refers to a non-linear conductive trace that follows a meandered path to increase the path length thereof. Using meandered conductive traces provides a convenient way to introduce higher levels of inductance in the dipole arm while keeping the physical footprint of the conductive traces small. As will be explained in further detail herein, the meandered conductive traces act as high impedance sections that to interrupt currents that otherwise would be induced on the dipole arms in response to RF radiation emitted by nearby mid-band and/or high-band radiating elements.

The meandered conductive traces are designed to create this high impedance for mid-band and high-band currents without significantly impacting the ability of the low-band currents to flow on the dipole arms. As such, the meandered conductive traces may reduce induced mid-band and/or high-band currents on the low-band radiating element and consequent disturbance to the antenna patterns of nearby mid-band and/or high-band arrays.

The lengths of the meandered conductive traces may be adjusted to change the frequency band where very deep levels of cloaking are achieved. Normally, the longer meandered conductive traces provide high cloaking levels in a lower portion of the cloaked frequency range, while the shorted meandered conductive traces provide high cloaking levels in the upper portion of the cloaked frequency band. Since a capacitive effect is also present, if the path lengths of the meandered conductive traces are too long then the low-band dipole arms may start to re-radiate high-band RF radiation, and the longer meandered conductive traces may also degrade the impedance match between the low-band dipole arms and the feed stalk of the low-band radiating element.

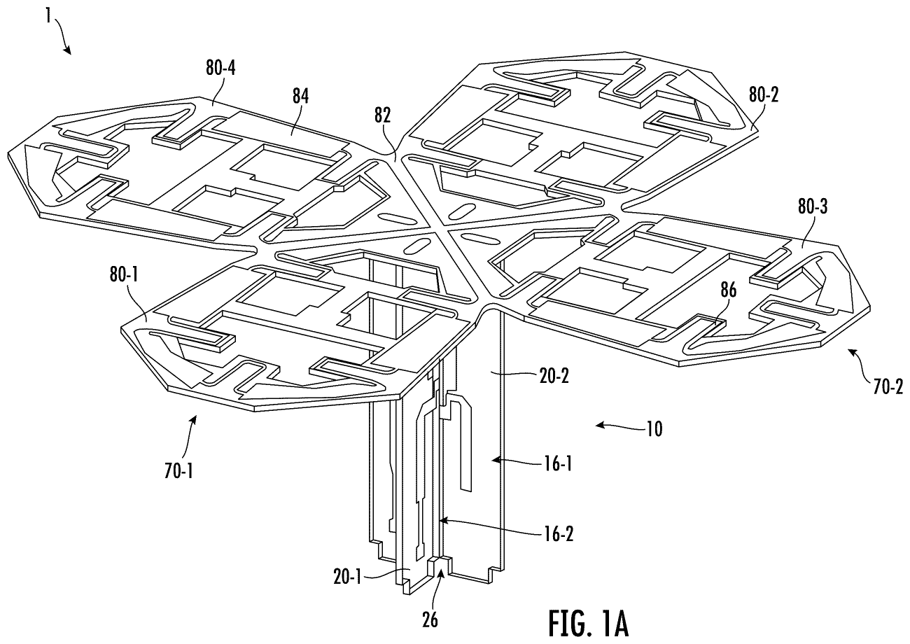

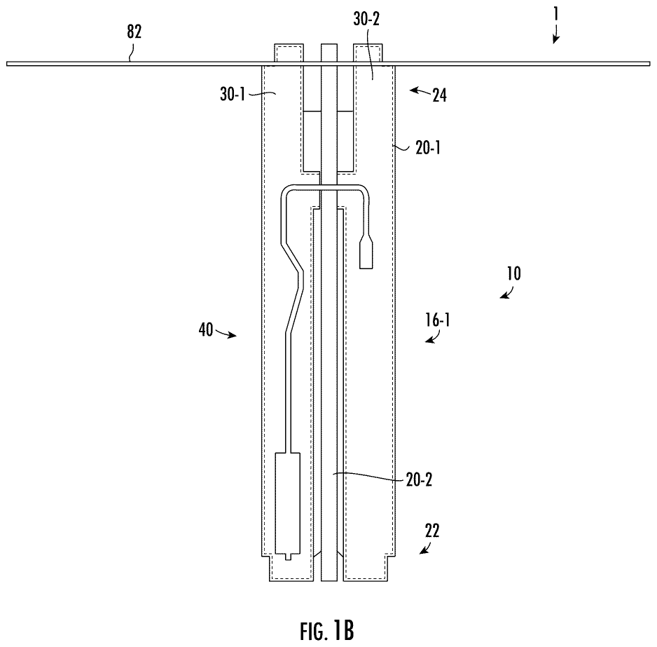

As will be discussed below with reference to FIGS. 1A-1B, radiating elements are known in the art that include a plurality of relatively wide conductive patches that are interconnected by a plurality of relatively narrow meandered conductive traces.

Various of the radiating elements according to embodiments of the present invention differ from these conventional radiating elements in that they include at least one meandered conductive trace that has a significantly longer path length, and hence significantly increased inductance. This increased inductance may act to broaden the cloaking bandwidth of the radiating element so that each dipole arm may be cloaked with respect to both mid-band and high-band radiating elements. In addition, the longer path length meandered conductive traces allow the dipole arm to achieve a desired electrical length in a smaller physical space, allowing the footprint of the low-band radiating elements according to embodiments of the present invention to be reduced as compared to conventional cloaking low-band radiating elements. Since the widths of many base station antennas are a function of the size of the low-band radiating elements, the radiating elements according to embodiments of the present invention may allow for the size of many base station antennas to be reduced without any loss in performance.

In some embodiments of the present invention, radiating elements are provided that include a feed stalk, a first dipole radiator that includes a first dipole arm and a second dipole arm, and a second dipole radiator that includes a third dipole arm and a fourth dipole arm. The first dipole arm comprises a base section, first and second side sections extending from the base section, and a distal section that electrically connects the first and second side sections, where the base section and the first and second side sections each comprises a plurality of conductive patches that are interconnected by a plurality of meandered conductive traces. The distal section comprises a first additional meandered conductive trace that has a path length that is at least three times longer than an average of the path lengths of the meandered conductive traces that are included in the base section and the first and second side sections.

In other embodiments of the present invention, radiating elements are provided that include a feed stalk, a first dipole radiator that includes a first dipole arm and a second dipole arm, and a second dipole radiator that includes a third dipole arm and a fourth dipole arm. The first dipole arm comprises a conductive loop and a first transverse meandered conductive trace that connects a first side section of the conductive loop to a second side section of the conductive loop.

In further embodiments of the present invention, radiating elements are provided that include a feed stalk, a first dipole radiator that includes a first dipole arm and a second dipole arm, and a second dipole radiator that includes a third dipole arm and a fourth dipole arm. The first dipole arm comprises a conductive loop that comprises a plurality of conductive patches that are interconnected by a plurality of meandered conductive traces. A first meandered conductive trace in the plurality of meandered conductive traces has a width that is at least three times less than an average of the widths of the conductive patches and a path length that is at least three times longer than an average of the path lengths of the conductive patches.

In any of the above embodiments, an average width of the conductive patches that are included in the base section and the first and second side sections may be at least three times an average width of the meandered conductive traces that are included in the base section and the first and second side sections. Moreover, the path length of the first additional meandered conductive trace may be at least five times longer than the average of the path lengths of the meandered conductive traces that are included in the base and first and second sides. At least a portion of the first meandered conductive trace may have a wave structure. The wave structure may have at least four outer bands and four inner bends. The first additional meandered conductive trace may galvanically connects the first side section to the second side section so that the first dipole arm comprises a conductive loop.

In any of the above embodiments, the feed stalk may comprise a feed stalk printed circuit board that includes a first feed line for the first dipole radiator and a second feed line for the second dipole radiator. The first through fourth dipole arms may, for example, be configured to be substantially transparent to RF radiation in the 1.6-2.7 GHz frequency band and in the 3.4-4.0 GHz frequency band.

In additional embodiments of the present invention, radiating elements are provided that include a feed stalk, a first dipole radiator that includes a first dipole arm and a second dipole arm, and a second dipole radiator that includes a third dipole arm and a fourth dipole arm. The first dipole arm that comprises a base section, first and second side sections extending from the base section, and first and second distal sections. The first distal section extends from a distal end of the first side section and includes a first plurality of fingers and the second distal section that extends from a distal end of the second side section and includes a second plurality of fingers. The first plurality of fingers are interdigitated with the second plurality of fingers.

Before discussing the radiating elements according to embodiments of the present invention it is helpful to discuss the design and operation of a representative conventional cloaked low-band radiating element for a base station antenna, as well as a base station antenna in which the radiating elements according to embodiments of the present invention may be used.

FIG. 1A is a perspective view of a conventional low-band cross-dipole radiating element 1. FIG. 1B is a shadow side view of cross-dipole radiating element 1. In FIG. 1B, the solid lines are the metallization patterns on a first side of feed stalk printed circuit board 20-1 and the dashed lines are the metallization patterns on a second (opposed) side of feed stalk printed circuit board 20-1. It should be noted that herein like elements may be referred to individually by their full reference numeral (e.g., feed stalk printed circuit board 20-2) and may be referred to collectively by the first part of their reference numeral (e.g., the feed stalk printed circuit boards 20).

As shown in FIG. 1A, the conventional cross-dipole radiating element 1 includes a feed stalk 10 and a pair of dipole radiators 70-1, 70-2. The feed stalk 10 comprises first and second feed stalk printed circuit boards 20-1, 20-2. Each feed stalk printed circuit board 20-1, 20-2 includes a respective RF feed line 16-1, 16-2 that carry RF signals between first and second RF transmission lines (not shown) that connect to the radiating element 1 to pass RF signals to and from the radiating element 1. Each such RF transmission line may comprise, for example, a coaxial cable or a microstrip transmission line on a feed board printed circuit board.

Referring to both FIGS. 1A and 1B, each feed stalk printed circuit board 20 has a base 22 and a distal end 24 that is positioned forwardly of the base 22. The first feed stalk printed circuit board 20-1 includes a slit 26 that extends forwardly from the base 22 thereof, and the second feed stalk printed circuit board 20-2 includes a slit 26 that extends rearwardly from the distal end 24 thereof. Feed stalk printed circuit boards 20-1 and 20-2 are arranged perpendicular to each other with the slits 26 thereof engaged so that the two mated feed stalk printed circuit boards 20-1, 20-2 have a cross-shape when viewed from the front.

Rear portions of each feed stalk printed circuit board 20 may include projections that are inserted through slits in a feed board printed circuit board (not shown). Metallized pads on the projections may be soldered to metallized pads on the feed board printed circuit board to mechanically mount the radiating element 1 on the feed board printed circuit board and to electrically connect the RF feed lines 16-1, 16-2 on the feed stalk 10 to the RF transmission lines on the feed board printed circuit board.

The dipole radiators 70-1, 70-2 are positioned at the distal ends 24 of the feed stalk printed circuit boards 20 and may be (and typically are) physically mounted on the feed stalk printed circuit boards 20. The first dipole radiator 70-1 extends along a first axis and the second dipole radiator 70-2 extends along a second axis that is generally perpendicular to the first axis. The first dipole radiator 70-1 includes first and second dipole arms 80-1, 80-2, and the second dipole radiator 70-2 includes third and fourth dipole arms 80-3, 80-4. The dipole radiators 70-1, 70-2 may be formed in a dipole radiator printed circuit board 82.

Dipole arms 80-1 and 80-2 of first dipole radiator 70-1 are center fed by the first RF feed line 16-1 on the first feed stalk printed circuit board 20-1 and radiate together at a first polarization. In the depicted embodiment, the first dipole radiator 70-1 is designed to transmit and receive signals having a slant +45° linear polarization. Dipole arms 80-3 and 80-4 of second dipole radiator 70-2 are center fed by the second RF feed line 16-2 on the second feed stalk printed circuit board 20-2 and radiate together at a second polarization that is orthogonal to the first polarization. The second dipole radiator 70-2 is designed to transmit and receive signals having a slant −45° linear polarization.

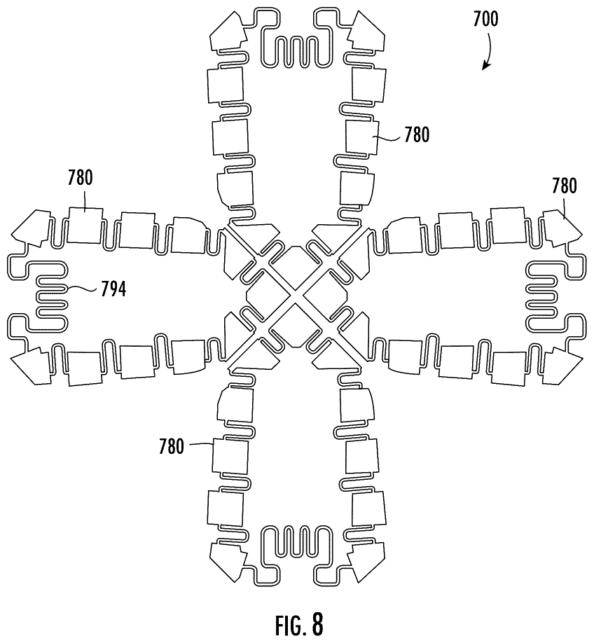

The dipole arms 80 are cloaking dipole arms that are formed as a series of relatively wide conductive patches 84 that are interconnected by relatively narrow meandered conductive traces 86 (see FIG. 1A). The average width of each conductive patch 84 may be at least three times, or at least four times, or at least five times the average width of each meandered conductive trace 86. The dipole radiators 70-1, 70-2 are shown as having an elongated “figure 8” shape where each dipole arm 80 is formed as a loop. The meandered conductive traces 86 act as high impedance sections that are designed to interrupt currents in the operating frequency band of the mid-band radiating elements that could otherwise be induced on dipole arms of the low-band radiating elements. The meandered conductive traces 86 may be designed to create this high impedance for currents in the operating frequency band of the mid-band radiating elements without significantly impacting the ability of the low-band currents to flow on the dipole arms. As a result, the low-band radiating elements may be substantially transparent to the mid-band radiating elements, and hence may have little or no impact on the antenna beams formed by the mid-band radiating elements.

As shown in FIG. 1B, a twin line transmission line structure is formed on the second side of feed stalk printed circuit board 20-1. The twin line transmission line structure comprises first and second ground lines 30-1, 30-2 that are implemented as first and second metallized regions that extend from the base 22 of the first feed stalk printed circuit board 20-1 to the distal end 24 thereof. Each ground line 30-1, 30-2 is coupled to the ground conductor of the first RF transmission line that feeds radiating element 1 (not shown). The first and second ground lines 30-1, 30-2 may each have an electrical length of about ¼ the center wavelength of radiating element 1.

A signal line 40 is formed on the first side of feed stalk printed circuit board 20-1. The signal line 40 is coupled to the signal conductor of the RF transmission line that feeds the first feed stalk printed circuit board 20-1. The signal line 40 extends forwardly from the base 22 of the first feed stalk printed circuit board 20-1 and travels about two-thirds of the way toward the distal end 24 thereof. The signal line 40 then goes through a first 90° turn to extend transversely across the first side of feed stalk printed circuit board 20-1.

Finally, the signal line 40 goes through a second 90° turn to extend rearwardly toward the base 22 of the first feed stalk printed circuit board 20-1.

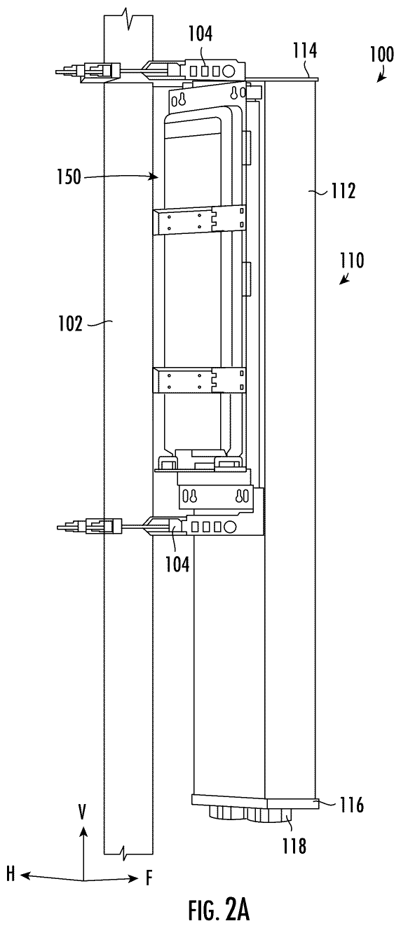

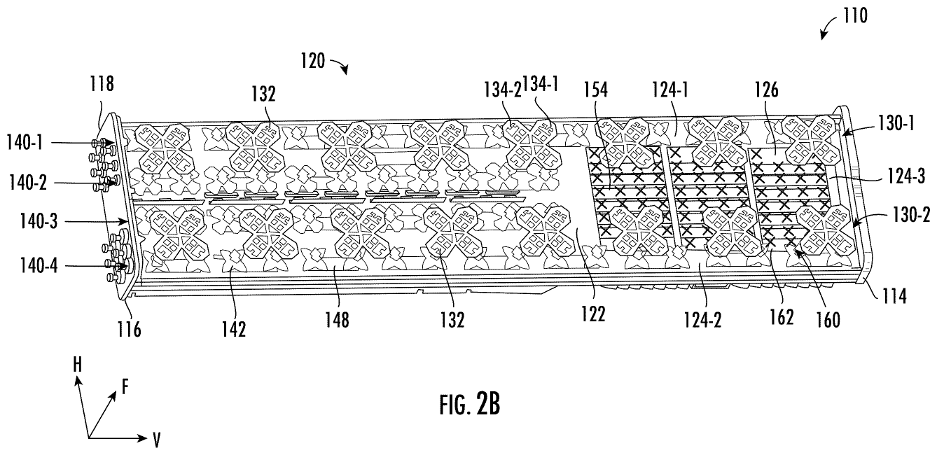

FIGS. 2A-2B illustrate a conventional passive/active antenna system 100 that includes both a passive base station antenna 110 and an active antenna module 150. In particular, FIG. 2A is a schematic rear perspective view of the passive/active antenna system 100, while FIG. 2B is a schematic perspective view of the passive/active antenna system 100 of FIG. 2A with radomes of both the passive base station antenna 110 and the active antenna module omitted. In FIGS. 2A and 2B, the axes illustrate the longitudinal (L), transverse (T) and forward (F) directions of the base station antenna system 100. In the description that follows, the antenna 100 and the radiating elements included therein will be described using terms that assume that the antenna 100 is mounted for normal use on a tower with a longitudinal axis of the antenna 100 extending along a vertical axis and the front surface of the antenna 100 mounted opposite the tower pointing toward the coverage area for the antenna 100.

Referring to FIG. 2A, the passive/active antenna system 100 may be mounted, for example, on an antenna tower 102 using mounting hardware 104. The active antenna module 150 may be mounted directly on a rear surface of the passive base station antenna 110, or may be held in place behind the passive base station antenna 110 by the mounting hardware 104. The front surface of the passive/active antenna system 100 may be opposite the antenna tower 102 facing toward a coverage area of the passive/active antenna system 100. The passive base station antenna 110 includes a tubular radome 112 that surrounds and protects an antenna assembly that is mounted inside the radome 112. A top end cap 114 covers a top opening in the radome 112 and a bottom end cap 116 covers a bottom opening in the radome 112. A plurality of RF ports 118 extend through the bottom end cap 116 and are used to connect the passive base station antenna 110 to one or more external radios (not shown). The active antenna module 150 may be removably mounted behind the passive base station antenna 110 so that the active antenna module 150 may later be replaced with a different active antenna module.

Referring to FIG. 2B, the passive base station antenna 110 includes a reflector assembly 120. The reflector assembly 120 may be referred to herein as a “passive reflector assembly” since it is part of the passive base station antenna 110. The passive reflector assembly 120 includes a main reflector 122 and spaced-apart first and second reflector strips 124-1, 124-2 that extend longitudinally from respective first and second opposed sides of the main reflector 122. The passive reflector assembly 120 may further include a third reflector strip 124-3 that extends in a transverse direction between top ends of the first and second reflector strips 124-1, 124-2. An opening 126 is defined between the first and second reflector strips 124-1, 124-2. For example, the opening 126 may be bounded by a top portion of the main reflector 122, the first and second reflector strips 124-1, 124-2, and the third reflector strip 124-3. At least the main reflector 122 may comprise or include a metallic surface (e.g., a sheet of aluminium) that serves as a reflector and ground plane for the radiating elements of the antenna 100. Various mechanical and electronic components of the antenna (not shown) may be mounted behind the passive reflector assembly 120 such as, for example, phase shifters, remote electronic tilt units, mechanical linkages, controllers, diplexers, and the like.

The passive base station antenna 110 further includes a plurality of passive linear arrays of radiating elements that extend forwardly from the passive reflector assembly 120. The linear arrays may support, for example, 2G, 3G and/or 4G cellular service. In the example passive base station antenna 110 shown in FIGS. 2A-2B, the linear arrays include first and second low-band linear arrays 130-1, 130-2 that are configured to operate in all or part of the 617-960 MHz frequency band. Each low-band linear array 130 comprises a vertically-extending column of low-band radiating elements 132. The passive base station antenna 110 further includes first through fourth mid-band linear arrays 140-1 through 140-4 that are configured to operate in all or part of the 1427-2690 MHz frequency band. Each mid-band linear array 140 comprises a vertically-extending column of mid-band radiating elements 142. Each of the low-band and mid-band linear arrays 130, 140 may generate relatively static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the cell).

Each of the low-band and mid-band radiating elements 132, 142 may be implemented as dual-polarized radiating elements that include first and second radiators that transmit and receive RF energy at orthogonal polarizations. When such dual-polarized radiating elements are used, each of the low-band and mid-band linear arrays 130, 140 may be connected to a pair of the RF ports 118. The first RF port 118 is connected between a first port of a radio (e.g., a remote radio head mounted on the antenna tower 102 near the passive base station antenna 110) and the first polarization radiators of the radiating elements in one of the linear arrays, and the second RF port 118 is connected between a second port of a radio and the second polarization radiators of the radiating elements in the linear array. RF signals that are to be transmitted by a selected one of the linear arrays 130, 140 are passed from the radio(s) to one of the RF ports 118, and passed from the RF port 118 to a power divider (or, alternatively, a phase shifter assembly that includes a power divider) that divides the RF signal into a plurality of sub-components that are fed to the respective first or second radiators of the radiating elements in the linear array, where the sub-components of the RF signal are radiated into free space.

The low-band and/or mid-band radiating elements 132, 142 may be mounted on feed board printed circuit boards that couple RF signals to and from the individual radiating elements 132, 142. In FIG. 2B, the mid-band radiating elements 142 are shown as being mounted in pairs on a plurality of mid-band feed board printed circuit boards 148 (the low-band radiating elements are likewise mounted on feed board printed circuit boards but they are not visible in the figure). Cables may be used to connect each feed board printed circuit board 148 to other components of the antenna such as diplexers, phase shifters or the like.

Most of the low-band and mid-band radiating elements 132, 142 are mounted to extend forwardly from the main reflector 122. However, low-band linear arrays 130-1, 130-2 extend substantially the full length of the passive/active antenna system 100 and hence extend beyond (above) the main reflector 122. The first and second reflector strips 124-1, 124-2 may provide mounting locations for low-band radiating elements 132 that are positioned above the main reflector 122. The first and second reflector strips 124-1, 124-2 may be integral with the main reflector 122 so that the first and second reflector strips 124-1, 124-2 and the main reflector 122 will be maintained at a common ground voltage, which may improve the performance of the low-band linear arrays 130-1, 130-2.

Each low-band radiating element 132 may comprise a slant −45°/+45° cross-dipole radiating element that includes a slant −45° polarization dipole radiator 134-1 and a slant +45° polarization dipole radiator 134-2. The dipole radiators 134-1, 134-2 may be mounted on a feed stalk (not shown). In some cases, the three uppermost low-band radiating elements 132 that are above the main reflector 122 may be mounted on a frequency selective surface (not shown) that covers the opening 126. This frequency selective surface is described in further detail below. In other cases, the low-band radiating elements 132 may include tilted feed stalks that allow these radiating elements to be mounted on the first and second reflector strips 124-1, 124-2 while the dipole radiators 134 of these radiating elements 132 are in front of the opening 126 (and any FSS covers the opening 126).

The active antenna module 150 includes a multi-column beamforming array 160 of radiating elements 162 and a beamforming radio (not visible in the figures). The multi-column beamforming array 160 may be mounted in a forward portion of the active antenna module 150, and the beamforming radio may be mounted behind the multi-column beamforming array 160. The beamforming array 160 may, for example, comprise a plurality of vertically-extending columns of high-band radiating elements 162 that are configured to operate in all or part of the 3.1-4.2 GHz frequency band (e.g., in the 3.4-4.0 GHz frequency band). The high-band radiating elements 162 are mounted to extend forwardly from a reflector 154 of the active antenna module 150 (herein the “active reflector”). The beamforming radio is capable of electronically adjusting the amplitude and/or phase of the subcomponents of an RF signal that are output to different radiating elements 162 of the multi-column beamforming array 160. For example, each port of the beamforming radio may be coupled to a column of radiating elements of the beamforming array 160, and the amplitudes and phases of the sub-components of the RF signals that are fed to each column may be adjusted so that the generated antenna beams are narrowed in the azimuth plane and pointed in a desired direction in the azimuth plane.

The beamforming array 160 of active antenna module 150 is mounted behind the opening 126 in the passive reflector assembly 114. The beamforming array 160 is visible in FIG. 2B as the frequency selective surface and the radome of the passive base station antenna 110 are omitted in FIG. 2B, as is the radome of the active antenna module 150. The opening 126 in the passive reflector assembly 120 allows the antenna beams generated by the beamforming array 160 to pass through the passive base station antenna 110 to provide service to the coverage area of the passive/active antenna system 100.

As discussed above, a frequency selective surface (not shown) may cover the opening 126. The frequency selective surface may be configured to allow RF energy emitted by the high band radiating elements 162 in the beamforming array 160 to pass therethrough, while the frequency selective surface reflects RF energy in lower frequency bands (and specifically, low-band RF signals that are emitted by the low-band radiating elements 132).

The frequency selective surface may be coplanar with the opening 126, in front of the opening 126 or behind the opening 126. The frequency selective surface can have a grid pattern such as a grid of metal pads and/or other metal structures. The grid pattern can be arranged in any suitable manner and may be symmetric or asymmetric across a width and/or length of the frequency selective surface. The grid pattern may comprise sub-wavelength periodic microstructures. The metal pads/structures may be arranged in one or more layers. The frequency selective surface may be formed on a substrate such as, for example, a printed circuit board or of stamped sheet metal. In some embodiments, the frequency selective surface may comprise a portion of the passive reflector assembly 120 that is stamped to form the metal grid structure therein. In such cases, the “opening 126” comprises a large number of small openings that act as a large opening with respect to RF energy in the operating frequency band of the beamforming array 160.

One difficulty with the passive/active base station antenna system 100 of FIGS. 2A-2B is that the top three low-band radiating elements 132 in each low-band linear array 130-1, 130-2 are mounted above the main reflector 122 and hence may be directly in front of the high-band beamforming array 160. As such, metal elements of the low-band radiating elements 132 may partially block/reflect the RF radiation emitted by the high-band beamforming array 160 and/or the high-band RF radiation may induce currents on metal elements of the low-band radiating elements 132 that then reradiate the high-band radiation in ways that act to distort the shape of the antenna beams generated by the high-band beamforming array 160. In addition, the outer two mid-band arrays 140-1, 140-4 include radiating elements 142 that are mounted above the main reflector 122 adjacent the low-band radiating elements. Thus, the top three low-band radiating elements 132 in each low-band linear array 130-1, 130-2 have the potential to negatively impact the antenna beams formed by mid-band arrays 140-1 and 140-4 and by the high-band beamforming array 160.

As discussed above, pursuant to embodiments of the present invention, cross-dipole low-band radiating elements are provided that have dipole arms that may be substantially transparent to RF energy in both the mid-band and high-band operating frequency bands. The low-band radiating elements may include resonant circuits having substantially higher inductance levels which can act to reduce formation of high-band currents on the dipole arms without significantly degrading the cloaking performance of the dipole arms in the mid-band operating frequency range.

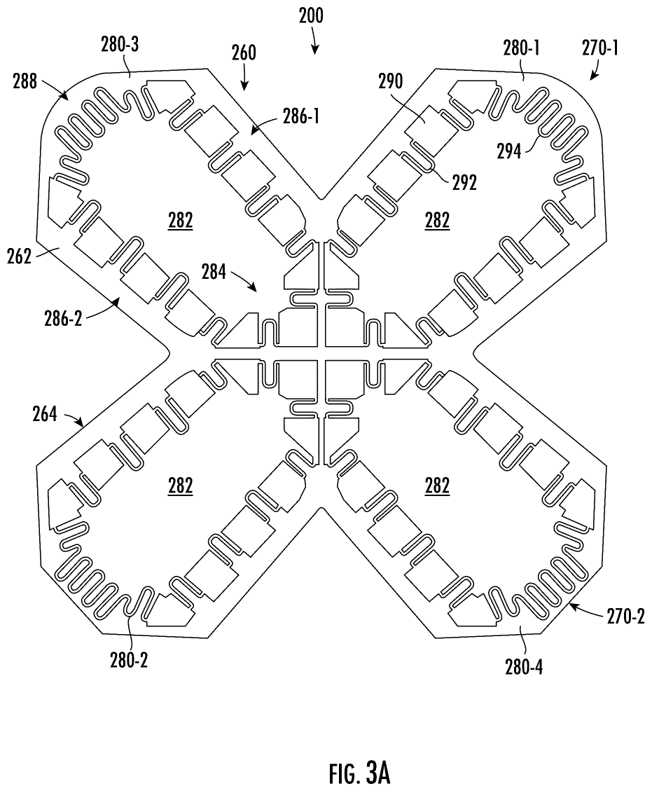

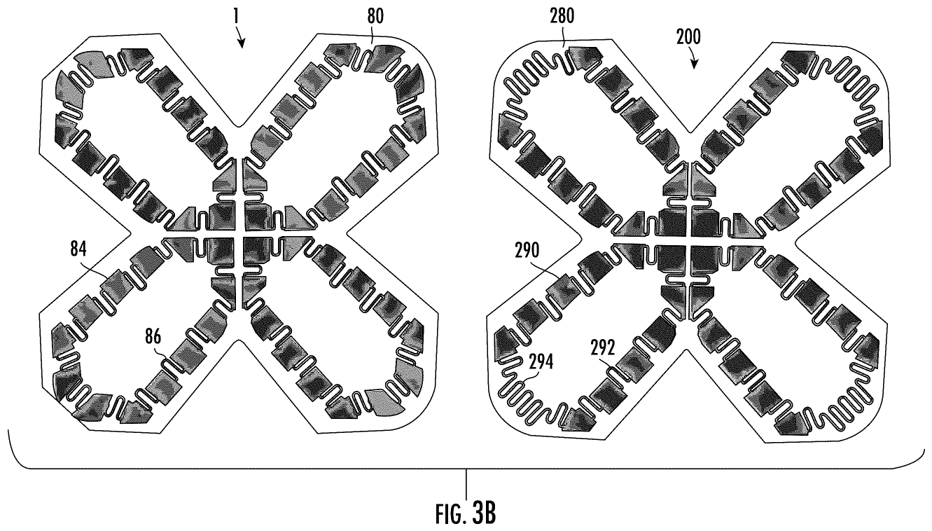

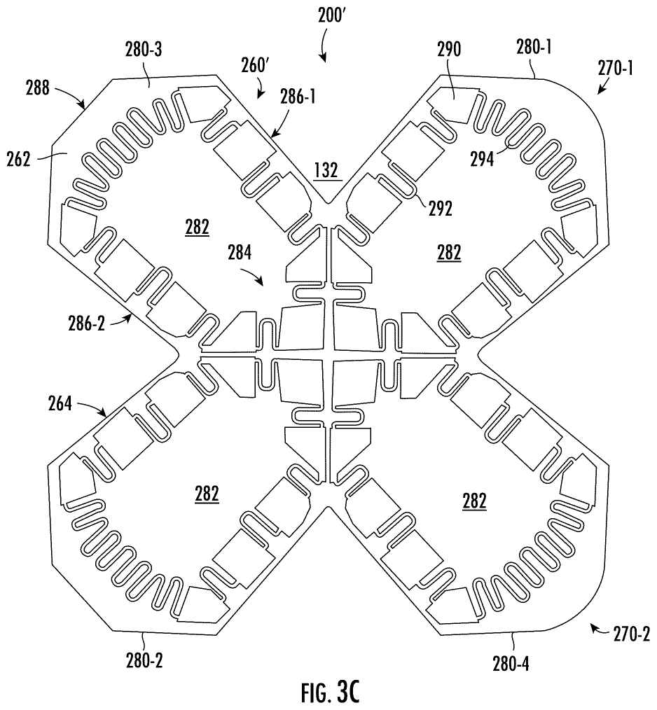

FIG. 3A is a schematic plan view of a low-band radiating element 200 according to embodiments of the present invention. FIG. 3B is a comparative diagram illustrating the current distribution on the dipole radiators of the conventional low-band radiating element of FIGS. 1A-1B as compared to the current distribution on the dipole radiators of the low-band radiating element of FIG. 3A. Only a dipole radiator printed circuit board 260 of the radiating element is shown in FIG. 3A. The dipole radiator printed circuit board 260 may include a dielectric substrate 262 with a metallization pattern 264 formed on one side thereof. While the feed stalk for the radiating element 200 is not shown in FIG. 3A, it will be appreciated that the feed stalk may be identical to the feed stalk 10 of the conventional radiating element 1 that is discussed above with reference to FIGS. 1A-1B.

The same is true with respect to the other radiating elements according to embodiments of the present invention that are disclosed herein. In other embodiments, the feed stalk may be implemented using a single feed stalk printed circuit board that includes first and second feed lines that feed the respective first and second dipole radiators of the radiating element 200.

As shown in FIG. 3A, the radiating element 200 includes a first dipole radiator 270-1, and a second dipole radiator 270-2. The dipole radiators 270-1, 270-2 are mounted adjacent (and typically on) the distal end of the feed stalk for the radiating element 200. The first dipole radiator 270-1 includes first and second dipole arms 280-1, 280-2, and the second dipole radiator 270-2 includes third and fourth dipole arms 280-3, 280-4.

Dipole arms 280-1 and 280-2 of the first dipole radiator 270-1 are center fed by a first RF feed line (not shown) and radiate together at a first polarization. In the depicted embodiment, the first dipole radiator 270-1 is designed to transmit and receive signals having a slant +45° linear polarization. Dipole arms 280-3 and 280-4 of the second dipole radiator 270-2 are center fed by the second RF feed line (not shown) and radiate together at a second polarization that is orthogonal to the first polarization. The second dipole radiator 270-2 is designed to transmit and receive signals having a slant −45° linear polarization Each dipole arm 280 is formed as a conductive loop 282 that has a generally oval shape. Each conductive loop 282 includes a base section 284, first and second side sections 286-1, 286-2 that extend from the base section 284, and a distal section 288 that connects distal ends of the first and second side sections 286-1, 286-2. The base section 284 and the first and second side sections 286-1, 286-2 of each conductive loop 282 each comprise a plurality of relatively wide conductive (e.g., metal) patches 290 that are interconnected by a plurality of relatively narrow meandered conductive (e.g., metal) traces 292. In the depicted embodiment, each base section 284 includes three conductive patches 290, each side section 286 includes four conductive patches 290, and the distal end 288 does not include any conductive patches 290. Similarly, in the depicted embodiment, each base section 284 includes four meandered conductive traces 292, each side section 286 includes three meandered conductive traces 292, and the distal end 288 includes a first additional meandered conductive trace 294. Each meandered conductive trace 292, 294 connects a respective pair of adjacent conductive patches 290.

Reference will be made herein to the widths of the conductive patches 290 and of the meandered conductive traces 292, 294. The width W1 of a conductive patch 290 refers to the maximum extent of the conductive patch 290 in a direction that is parallel to the major surfaces of the conductive patch 290 and perpendicular to the main direction of current flow through the conductive patch 290. Similarly, the width W2 of a meandered conductive trace 292, 294 refers to the maximum extent of the meandered conductive trace 292, 294 in a direction that is parallel to the major surfaces of the meandered conductive trace 292, 294 and perpendicular to the main direction of current flow through the meandered conductive trace 292, 294. As shown in FIG. 3A, the width W2 of each meandered conductive trace 292, 294 may be significantly less than the widths W1 of the conductive patches 290. Since the conductive patches 290 need not all have the same widths W1, reference may be made herein to the average width of the conductive patches 290. Similarly, since the meandered conductive traces 292 need not all have the same widths W2, reference may be made herein to the average width of the meandered conductive traces 292. In the depicted embodiment, each meandered conductive trace 292 has a width W2 that is about 15% the average width of the conductive patches 290. In other embodiments, each meandered conductive trace 292 may have a width W2 that is less than 50%, less than 33.3%, less than 25% or less than 10% the average width of the conductive patches 290.

The meandered conductive traces 292 that are included in the base section 284 and in the first and second side sections 286-1, 286-2 of each conductive loop 282 each have an elongated U-shape. This allows each meandered conductive trace 292 to fit in between two closely spaced apart conductive patches 290 while having a path length that exceeds the path length of the conductive patches 290. Herein the term “path length” refers to the distance that an electrical current flowing through the most direct current path through a conductive structure will travel when traversing the conductive structure. Since the conductive patches 290 have generally square or triangular shapes, the path length for the conductive patches 290 will typically be the physical distance between the point where the current enters the conductive patch 290 to the point where the current exits the conductive patch 290. For the meandered conductive traces 292, the “path length” is the physical length of the trace were it possible to pull on both ends of the trace so that the trace extended along an axis. Since the conductive patches 290 and/or the meandered conductive traces 292 need not all have the same path lengths, reference may be made herein to the average path lengths of the conductive segments 290 and/or to the average path length of the meandered conductive traces 292. In the depicted embodiment, each meandered conductive trace 292 has a path length that is about twice the average path length of the conductive patches 290. In other embodiments, each meandered conductive trace 292 may have a path length that is at least 1.5 times, at least twice or at least three times the average path length of the conductive patches 290.

As noted above, the distal section 288 of each conductive loop 282 comprises a relatively narrow meandered conductive (e.g., metal) trace 294. The meandered conductive trace 294 may have a path length that is longer than, and typically significantly longer than, the average path length of the meandered conductive traces 292 that are included in the base section 284 and the first and second side sections 286-1, 286-2 of each conductive loop 282. Thus, herein the meandered conductive trace 294 may be referred to as a first additional meandered conductive trace to help distinguish the elongated meandered conductive trace 294 from the shorter meandered conductive traces 292 included in the base section 284 and the first and second side sections 286-1, 286-2 of each conductive loop 282. As shown, the first additional meandered conductive trace 294 may have a wave structure where the conductive trace has inner bends and outer bends. In the depicted embodiment, the first additional meandered conductive trace 294 has six outer bends and seven inner bends. A central portion of the first additional meandered conductive trace 294 has a square wave structure where the conductive trace has sections that extend generally parallel to each other. In the depicted embodiment, each first additional meandered conductive trace 294 has a path length that is about than six times the average path length of the meandered conductive traces 292 that are included in the base section 284 and first and second side sections 286-1, 286-2 of the respective conductive loops 282.

The first additional meandered conductive traces 294 may significantly increase the inductance of the equivalent circuit defined by the respective dipole arms 280.

The present application is based, in part, on the realization that this increased inductance may act to broaden the cloaking bandwidth of the radiating element 200 so that each dipole arm 280 may be cloaked with respect to both mid-band RF radiation and high-band RF radiation. This can be seen in FIG. 3B, which is a comparative diagram illustrating the current distribution on the dipole radiators 80 of the conventional radiating element 1 of FIGS. 1A-1B as compared to the current distribution on the dipole radiators 280 of the radiating element 200 according to embodiments of the present invention of FIG. 3A in response to RF radiation emitted by a nearby high-band radiating element. In FIG. 3B, the coloring of the metal dipole arms indicate the current densities thereon, with colors on the lower wavelength end of color spectrum (violet, dark blue) indicating very low current densities and colors on the higher wavelength end of the color spectrum (orange, red) indicating high current densities.

As shown in FIG. 3B, in the conventional radiating element 1, very high current densities are present in the meandered conductive traces 86 and moderate current levels are present in many of the conductive patches 84. In the radiating element 200 according to embodiments of the present invention, the current levels in both the meandered conductive traces 292 and in the conductive patches 290 are reduced. Moreover, the narrow meandered conductive traces 292 tend to not radiate RF energy in response to current thereon, so the amount of high-band radiation emitted by the dipole arms 280 of the radiating element 200 in response to incident high-band RF radiation may be very low. In contrast, low-band currents may freely form and flow on the dipole arms 280 to ensure that the radiating element 200 has high directivity that is substantially equivalent to the directivity of a conventional low-band radiating element.

It can be particularly challenging to design cloaked low-band radiating elements for base station antennas that also include both mid-band and high-band arrays of radiating elements because conventional cloaking techniques tend to have narrow-band responses. Thus, one conventional solution for cloaking low-band radiating elements is to cloak the dipole arms of a radiating element that are closest to high-band radiating elements so that they are cloaked with respect to high-band RF radiation and to cloak the dipole arms of the radiating element that are closest to mid-band radiating elements so that they are cloaked with respect to mid-band RF radiation. This approach is disclosed in U.S. Pat. No. 11,018,437 (herein “the '437 patent”), the entire content of which is incorporated herein by reference. However, in cases where both mid-band and high-band radiating elements are in close proximity to some of the dipole arms of a low-band radiating element, the approach taken in the '437 patent may not work well, as a dipole arm that is cloaked for high-band RF radiation may not be well cloaked with respect to the RF radiation emitted by nearby mid-band radiating elements, and/or as a dipole arm that is cloaked for mid-band RF radiation may not be well cloaked with respect to the RF radiation emitted by nearby high-band radiating elements.

Moreover, an additional challenge is that the cloaking levels that are necessary at high-band may be very stringent, as the high-band radiating elements are typically part of active beamforming arrays that generate narrowed antenna beams that are electronically scanned (e.g., in the azimuth plane). Since the high-band antenna beams are more focused, high-band RF radiation that is re-transmitted from a dipole arm of a nearby low-band radiating element is less likely to be transmitted in a desired direction, and thus even higher cloaking levels may be needed with respect to high-band RF radiation to ensure that the high-band array has adequate performance.

The radiating element 200 may exhibit very high cloaking levels with respect to high-band RF radiation and RF radiation in the upper portion of the mid-band frequency range where beamforming arrays are often used (e.g., RF radiation in the 2.5-4.0 GHz frequency range) while also providing reasonably high cloaking levels throughout the remainder of the mid-band frequency range. Thus, the cloaking low-band radiating element 200 may provide sufficient cloaking levels over a very broad frequency range (here 1.7-4.0 GHz).

The radiating element 200 may operate over the full 617-960 MHz low-band frequency range, and may generate antenna beams that have relatively narrow azimuth and elevation beamwidths, thereby providing good (high) gain performance. However, another advantage of the low-band radiating element designs disclosed herein such as the radiating element 200 is that the longer path length provided by the first additional meandered conductive traces 294 allow the dipole arms 280 to achieve a desired electrical length in a smaller physical space. As such, the footprint of the low-band radiating elements according to embodiments of the present invention can be reduced as compared to conventional cloaking low-band radiating elements (herein, the footprint of a radiating element refers to the area of the smallest rectangle that encloses the dipole radiators of the radiating element when the radiating element is viewed from the front). For example, the dipole radiators 80 of the conventional low-band radiating element 1 of FIGS. 1A-1B, which is designed to operate in the 694-960 MHz frequency band, define a square that is 150 mm on each side when viewed from the front. The dipole radiators 280 of the radiating element 200 of FIG. 3A may define a square that is 152 mm on each side when viewed from the front, and hence may have almost the exact same footprint. Moreover, the low-band radiating element 200 of FIG. 3A is designed to operate in the wider 617-960 MHz frequency band, and thus a version of radiating element 200 that was designed to only operate in the 694-960 MHz frequency band would have a smaller footprint than the conventional low-band radiating element 1 of FIGS. 1A-1B. At the same time, the low-band radiating element 200 provides significantly improved cloaking performance (as it is cloaked over both the mid-band and high-band frequency ranges).

While radiating element 200 is a low-band radiating element, it will be appreciated that the same techniques may be used to provide mid-band radiating elements that achieve very high cloaking levels with respect to high-band RF radiation. Thus, by, for example, merely scaling the size of the elements forming radiating element 200 a mid-band radiating element may be provided that suppresses formation of high-band currents on the dipole arms thereof and of subsequent re-radiation of high-band energy.

Since the widths of many base station antennas are a function of the size of the low-band radiating elements, the radiating elements according to embodiments of the present invention may allow for the size of many base station antennas to be reduced while providing performance improvements. For example, FIG. 3C is a plan view of the dipole radiator printed circuit board 260′ of a modified version 200′ of radiating element 200. As can be seen by comparing FIGS. 3A and 3C, the differences between radiating elements 200 and 200′ are (1) that each side section 286-1, 286-2 includes one less conductive patch 290 and one less meandered conductive trace 292 and (2) the first additional meandered conductive trace 294 is shorter in radiating element 200′. This allows the dipole printed circuit board 260′ of radiating element 200′ to fit within a square that is only 132 mm on each side (i.e., it has a significantly reduced footprint). While the use of the smaller radiating element 200′ may result in a decrease in gain, it may also allow including arrays of low-band radiating elements in base station antennas having narrower antenna housings.

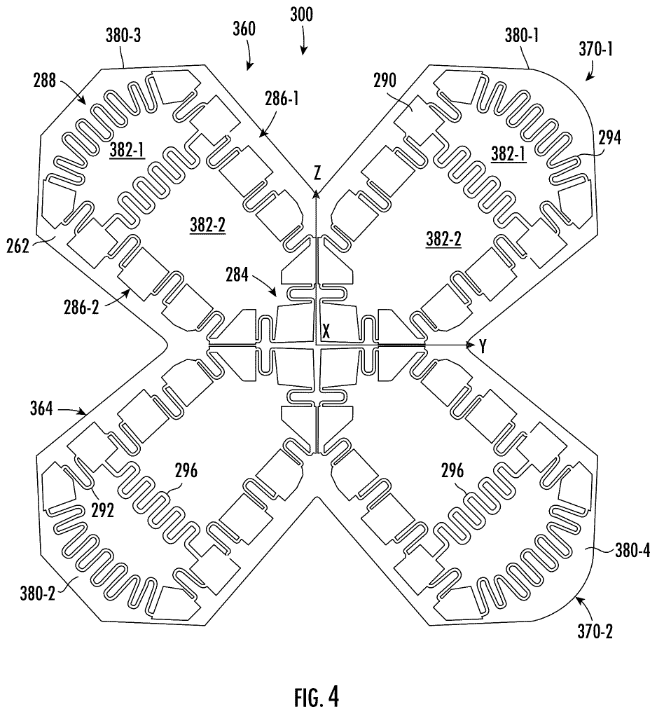

FIG. 4 is a schematic plan view of a dipole radiator printed circuit board 360 of a radiating element 300 according to further embodiments of the present invention. The radiating element 300 is similar to the radiating element 200 of FIG. 3A discussed above, and hence the discussion below will focus on the differences between the two radiating elements 200, 300. Like elements are identified using the same reference numerals in FIGS. 3A and 4.

As can be seen, radiating element 300 includes a first dipole radiator 370-1 that has first and second dipole arms 380-1, 380-2 and a second dipole radiator 370-2 that includes third and fourth dipole arms 380-3, 380-4. The dipole radiators 370 are implemented on a dipole radiator printed circuit board 360 that includes a dielectric substrate 262 with a metallization pattern 364 thereon. The radiating element 300 may be identical to radiating element 200 except that each dipole arm 380 of radiating element 300 further includes a second additional meandered conductive trace 296 that connects the first side section 286-1 of the dipole arm 380 to the second side section 286-2. The addition of the second additional meandered conductive trace 296 means that each dipole arm 380 of radiating element 300 includes a first conductive loop 382-1 that comprises the base section 284, the first and second side sections 286-1, 286-2 and the distal section 288 of the dipole arm 380 (i.e., the first conductive loop 382-1 may be identical to the conductive loop 282 of each dipole arm 280 of radiating element 200 of FIG. 3A), as well as a second conductive loop 382-2 that comprises the base section 284, the first and second side sections 286-1, 286-2 and the second additional meandered conductive trace 296.

It was determined that the gain of radiating element 200 was reduced in the upper portion of the 617-960 MHz operating frequency band by nearly 5 dB. As described in U.S. Patent Publication No. 2022/0123478, the entire content of which is incorporated herein by reference, by forming multiple conductive loops in the dipole arms of a radiating element the operating frequency band of the radiating element may be increased. In particular, RF currents in the higher end of the operating frequency band will tend to traverse the smaller of two conductive loops (as they will be resonant in the metallization structure of the smaller loop), while RF currents in the lower end of the operating frequency band will tend to traverse the larger of two conductive loops. Radiating element 300 may have the same size as radiating element 200, and the inclusion of the second additional meandered conductive trace 296 in each dipole arm 380 may completely eliminate the reduction in gain that occurs in the higher portion of the operating frequency band in radiating element 200.

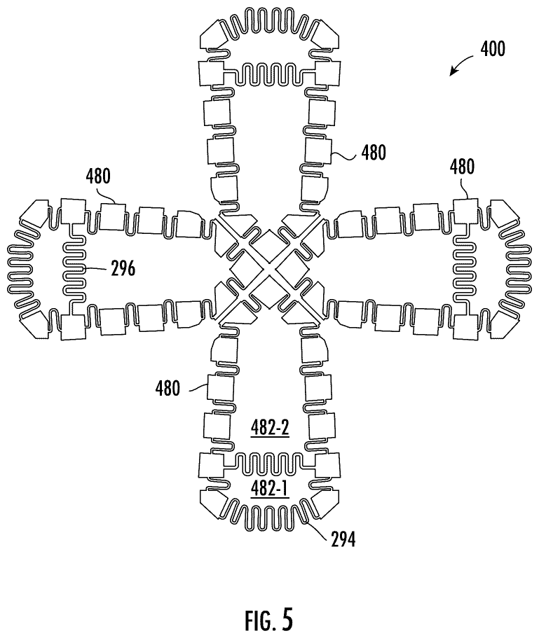

It will be appreciated that many modifications may be made to the low-band radiating elements 200, 200′, 300 discussed above without departing from the scope of the present invention. FIGS. 5-13 illustrate further examples of radiating elements according to embodiments of the present invention that may exhibit improved cloaking performance.

FIG. 5 is a schematic plan view of the dipole radiator design of a radiating element 400 according to further embodiments of the present invention. As shown in FIG. 5, the dipole arms 480 may have a variety of different shapes. In particular, the low-band radiating element 400 shown in FIG. 5 has dipole arms 480 that form more elongated conductive loops 482-1. This may improve the cross-polarization discrimination of the radiating element 400, but at the expense of a further increase in the size thereof. While the embodiment shown in FIG. 5 includes both the first and second additional meandered conductive traces 294, 296, it will be appreciated that in other embodiments the second additional meandered conductive trace 296 may be omitted.

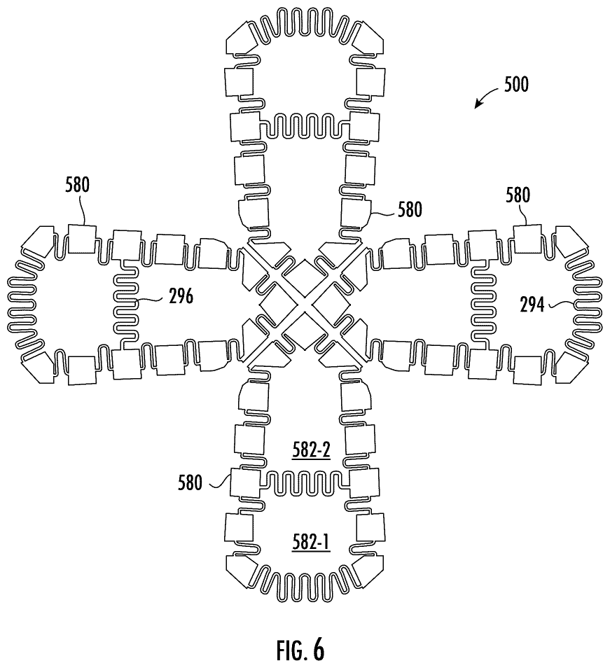

FIG. 6 is a schematic plan view of the dipole radiator design of a radiating element 600 according to further embodiments of the present invention. The dipole radiators of radiating element 500 may be identical to the dipole radiators of radiating element 400 of FIG. 5, except that the second additional meandered conductive trace 296 included in each dipole arm 580 of radiating element 500 is connected between different conductive patches 290 so that the path length of the second conductive loop 582-2 formed in each dipole arm 580 is shortened. FIGS. 5 and 6 together illustrate that the path lengths of the second conductive loops 482-2, 582-2 may be selected to optimize desired performance parameters of the radiating elements according to embodiments of the present invention.

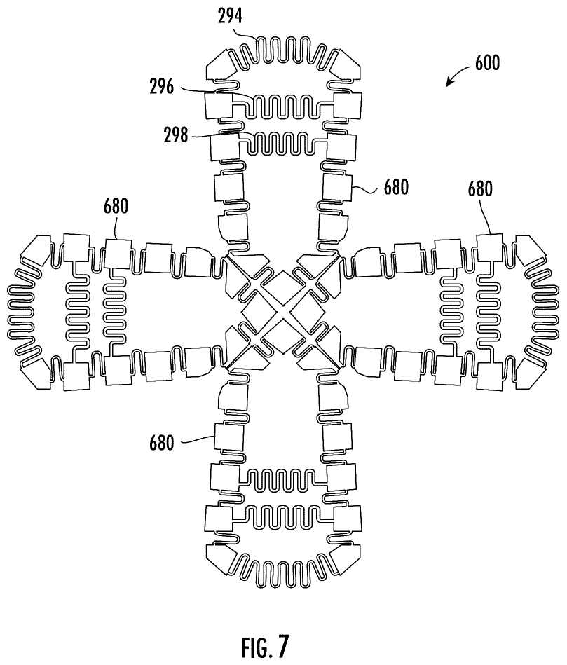

FIG. 7 is a schematic plan view of the dipole radiator design of a radiating element 600 according to further embodiments of the present invention. The dipole radiators of radiating element 600 may be identical to the dipole radiators of radiating element 400 of FIG. 5, except that a third additional meandered conductive trace 298 is included in each dipole arm 680 of radiating element 600. By adding a third additional meandered conductive trace 298 to each dipole arm 680 each dipole arm 680 includes three conductive loops 282-1, 282-2, 282-3, each of which has a different respective path length. This technique may be used to further widen the operating frequency band of the radiating element. It will be appreciated that the dipole arms of any of the radiating elements disclosed herein may be modified to include a third additional meandered conductive trace 298.

FIG. 8 is a schematic plan view of the dipole radiator design of a radiating element 700 according to further embodiments of the present invention. The dipole radiators of radiating element 700 may be identical to the dipole radiators of radiating element 400 of FIG. 5, except that (1) the second additional meandered conductive trace 296 is omitted from each dipole arm 780 and (2) the first additional meandered conductive trace 794 that is included in each dipole arm 780 of radiating element 700 has a different design. The first additional meandered conductive trace 794 is designed to generate increased capacitance as compared to the first additional meandered conductive trace 294 included in each dipole arm 280 of the radiating element 400 of FIG. 5.

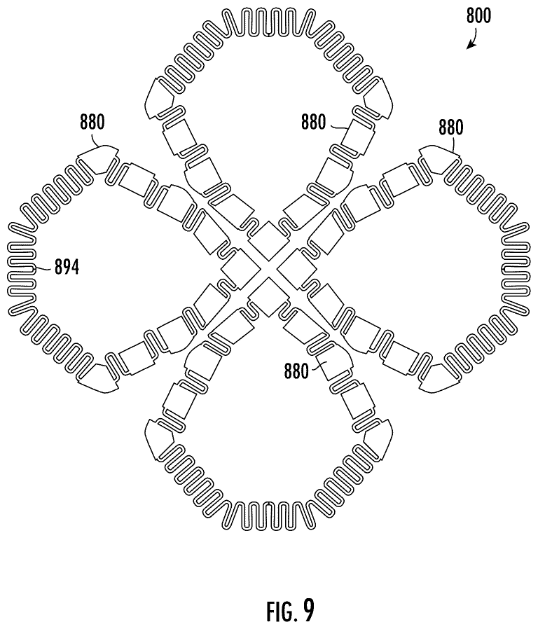

FIG. 9 is a schematic plan view of the dipole radiator design of a radiating element 800 according to yet additional embodiments of the present invention. The dipole radiators of radiating element 800 differ from the dipole radiators of the previously discussed embodiments in that (1) the path length of the first additional meandered conductive trace 894 that is included in each dipole arm 880 of radiating element 800 is increased significantly, resulting in a significant additional increase in inductance and (2) the shape of each dipole arm 580 is made more rounded to provide additional room at the distal end of each dipole arm 580 for the lengthened first additional meandered conductive traces 894.

FIGS. 8 and 9 illustrate that by changing the relative amounts of inductance and/or capacitance added by the first additional meandered conductive trace 294, 794, 894 the cloaking response of the radiating elements according to embodiments of the present invention may be fine tuned to achieve desired performance levels.

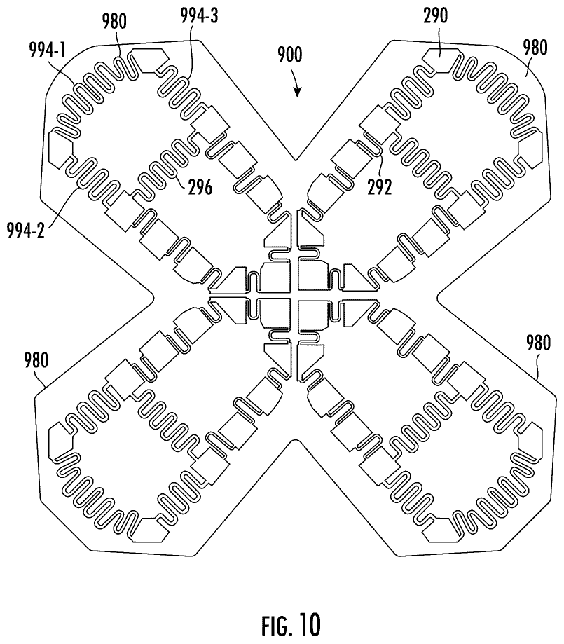

It will also be appreciated that meandered conductive traces that have extended path lengths may be positioned in other locations of the dipole arms. FIG. 10 is a schematic plan view of the dipole radiator design of a radiating element 900 according to further embodiments of the present invention that includes dipole arms that each have three first additional meandered conductive traces 984-1 through 984-3. As can be seen by comparing FIGS. 6 and 10, the radiating element 900 is similar to radiating element 500 of FIG. 6, except that in radiating element 900 one of the conductive patches 290 and two of the meandered conductive traces 292 that are included in each of the first and second side sections 286-1, 286-2 of each dipole arm 280 are replaced in radiating element 900 with an elongated first additional meandered conductive trace 984. As such, the dipole arms 980 of radiating element 900 will have increased inductance as compared to the dipole arms 580 of radiating element 500.

It should be noted that as the number of first additional meandered conductive traces that are included in a dipole arm is increased it may be possible to reduce the path length of some or all of the first additional meandered conductive traces while keeping the total amount of inductance constant. Thus, in still further embodiments, additional conductive patches 290 and their connected meandered conductive traces 292 may each be replaced with a first additional meandered conductive trace 994. In practice, however, it may be easier to impedance match the feed stalk of the radiating elements according to embodiments of the present invention to the dipole radiators thereof if the extra-elongated meandered conductive traces are positioned closer to the distal ends of the respective dipole arms. Thus, it may be preferable to use fewer (e.g., 1 or 3) extra-elongated meandered conductive traces that are positioned at or close to the distal ends of the respective dipole arms.

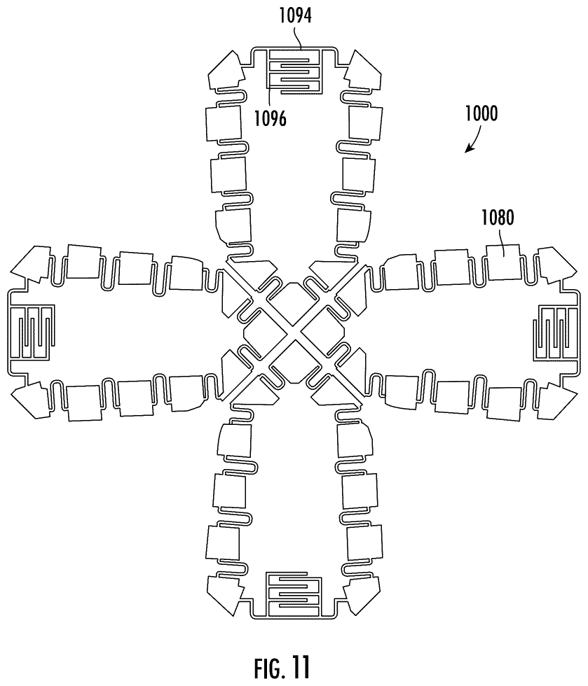

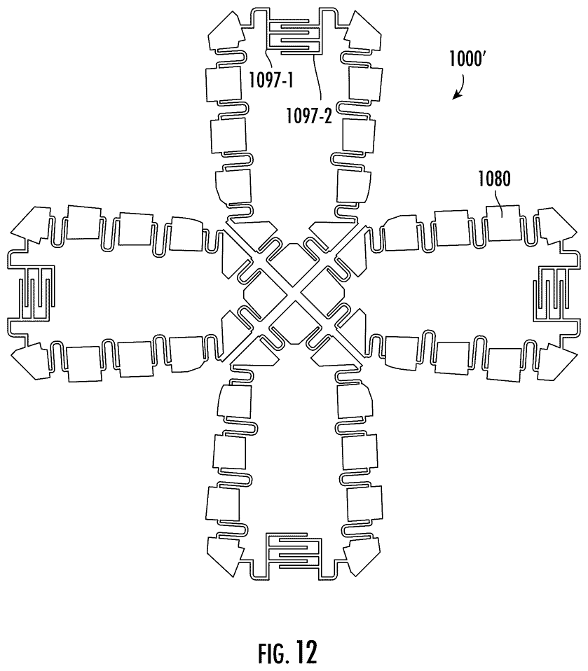

It will also be appreciated that the first additional meandered conductive traces of the above-described embodiments may be replaced with other reactive structures. For example, FIG. 11 is a schematic plan view of the dipole radiator design of a radiating element 1000 according to further embodiments of the present invention that replaces the first additional meandered conductive traces 294 of the radiating element 400 of FIG. 5 with slightly meandered conductive traces 1094 that further include interdigitated fingers 1096 that will exhibit increased capacitance. This may provide a convenient way to increase the capacitance of each dipole arm while also reducing the inductance thereof. FIG. 12 is a schematic plan view of the dipole radiator design of a radiating element 1000′ according to further embodiments of the present invention that is a modified version of radiating element 1000. In radiating element 1000′, no direct galvanic connection is provided at the distal end of each dipole arm so that the only electrical connection at the distal end of each dipole arm is the capacitor formed by the interdigitated fingers of the two trace structures 1097-1, 1097-2 that form the distal section of each dipole arm. This may further increase the capacitance of each dipole arm while further reducing the inductance thereof.

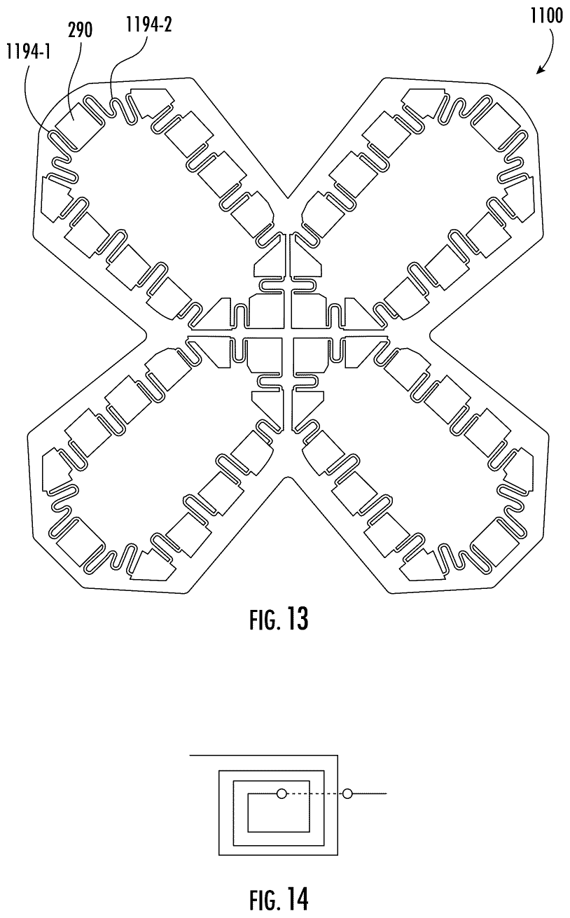

FIG. 13 is a schematic plan view of the dipole radiator design of a radiating element 1100 according to further embodiments of the present invention. The dipole radiators of radiating element 1100 may be identical to the dipole radiators of radiating element 200 of FIG. 3A, except that the first additional meandered conductive trace 294 that is included in each dipole arm 280 of radiating element 200 is replaced in radiating element 1100 with a pair of shorter first additional meandered conductive trace 1194-1, 1194-2 and a conductive patch 290. The design of radiating element 1100 adds less inductance than the design of radiating element 200.

It will be appreciated that the above-described embodiments are merely examples of radiating elements according to embodiments of the present invention and that many changes may be made to the embodiments disclosed above. For example, the first additional meandered conductive traces could be implemented in full or in part as spiral inductors that are formed using metallization on both sides of the printed circuit board. An example of such a spiral inductor is shown in FIG. 14.

It will be appreciated that many modifications may be made to the radiating elements discussed above without departing from the scope of the present invention. For example, the above-described radiating elements are formed using feed stalk printed circuit boards. In other embodiments, other types of feed stalk implementations may be used such as, for example, sheet metal feed stalks. As another example, while the radiating elements according to embodiments of the present invention are described above as low-band radiating elements that cloak in the mid-band and the high-band frequency ranges, in other embodiments the radiating element could be mid-band radiating elements that are cloaked across a broader range of the high-band operating frequency range.

While the dipole arms of the low-band radiating elements described above are implemented in dipole radiator printed circuit boards, it will be appreciated that embodiments of the present invention are not limited thereto. For example, in other embodiments, the dipole arms may be implemented as sheet metal dipole arms or using other metal structures.

The radiating elements according to embodiments of the present invention may be included in multi-band base station antennas, and may reduce the amount of interaction between the arrays in the different frequency bands. Base station antennas that include the radiating elements according to embodiments of the present invention may be used, for example, as sector antennas in the above-described cellular communications systems.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms.

These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A radiating element, comprising
a feed stalk;
a first dipole radiator that includes a first dipole arm and a second dipole arm; and
a second dipole radiator that includes a third dipole arm and a fourth dipole arm;
wherein the first dipole arm comprises a base section, first and second side sections extending from the base section, and a distal section that electrically connects the first and second side sections,
wherein the base section and the first and second side sections each comprises a plurality of conductive patches that are interconnected by a plurality of meandered conductive traces, and
wherein the distal section comprises a first additional meandered conductive trace that has a path length that is at least three times longer than an average of the path lengths of the meandered conductive traces that are included in the base section and the first and second side sections.

2. The radiating element of claim 1, wherein an average width of the conductive patches that are included in the base section and the first and second side sections is at least three times an average width of the meandered conductive traces that are included in the base section and the first and second side sections.

3. The radiating element of claim 2, wherein the path length of the first additional meandered conductive trace is at least five times longer than the average of the path lengths of the meandered conductive traces that are included in the base and first and second side sections.

4. The radiating element of claim 1, wherein at least a portion of the first meandered conductive trace has a wave structure.

5-6. (canceled)

7. The radiating element of claim 1, wherein the first through fourth dipole arms are configured to be substantially transparent to RF radiation in the 1.6-2.7 GHz frequency band and in the 3.4-4.0 GHz frequency band.

8. The radiating element of claim 1, wherein the first additional meandered conductive trace galvanically connects the first side section to the second side section so that the first dipole arm comprises a conductive loop.

9-11. (canceled)

12. The radiating element of claim 1, wherein the first dipole arm further comprises a first transverse meandered conductive trace that connects the first side section to the second side section.

13. The radiating element of claim 12, wherein a path length of the first transverse meandered conductive trace is at least three times longer than the average of the path lengths of the meandered conductive traces that are included in the base section and the first and second side sections.

14. The radiating element of claim 12, wherein the first dipole arm further comprises a second transverse meandered conductive trace that connects the first side section to the second side section.

15. The radiating element of claim 14, wherein a path length of the second transverse meandered conductive trace is at least three times longer than the average of the path lengths of the meandered conductive traces that are included in the base section and the first and second side sections

16. The radiating element of claim 12, wherein at least a portion of the first transverse meandered conductive trace has a wave structure.

17. (canceled)

18. A radiating element, comprising
a feed stalk;
a first dipole radiator that includes a first dipole arm and a second dipole arm; and
a second dipole radiator that includes a third dipole arm and a fourth dipole arm;
wherein the first dipole arm comprises a conductive loop and a first transverse meandered conductive trace that connects a first side section of the conductive loop to a second side section of the conductive loop, where the first transverse meandered conductive trace divides the conductive loop into an inner loop and an outer loop.

19. The radiating element of claim 18, wherein the first dipole arm further comprises a base section and a distal section, and the first and second side sections are positioned in between the base section and the distal section, and wherein the base section and the first and second side sections each comprises a plurality of conductive patches that are interconnected by a plurality of meandered conductive traces.

20. The radiating element of claim 19, wherein the distal section comprises a first additional meandered conductive trace that has a path length that is at least three times longer than an average of the path lengths of the meandered conductive traces in the plurality of meandered conductive traces.

21. The radiating element of claim 19, wherein a path length of the first transverse meandered conductive trace is at least three times longer than the average of the path lengths of the meandered conductive traces in the plurality of meandered conductive traces.

22. The radiating element of claim 21, wherein an average width of the conductive patches is at least three times an average width of the meandered conductive traces in the plurality of meandered conductive traces.

23. The radiating element of claim 22, wherein the path length of the first additional meandered conductive trace is at least six times longer than the average of the path lengths of the meandered conductive traces in the plurality of meandered conductive traces.

24-26. (canceled)

27. A radiating element, comprising
a feed stalk;
a first dipole radiator that includes a first dipole arm and a second dipole arm; and
a second dipole radiator that includes a third dipole arm and a fourth dipole arm;
wherein the first dipole arm comprises a conductive loop that comprises a plurality of conductive patches that are interconnected by a plurality of meandered conductive traces, and
wherein a first meandered conductive trace in the plurality of meandered conductive traces has a width that is at least three times less than an average of the widths of the conductive patches and a path length that is at least three times longer than an average of the path lengths of the conductive patches.

28. The radiating element of claim 27, wherein a base of the first dipole arm is adjacent a base of the second dipole arm, and wherein the first narrowed meandered conductive trace is positioned at a distal end of the first dipole arm.

29. The radiating element of claim 27, wherein a second meandered conductive trace in the plurality of meandered conductive traces has a width that is at least three times less than the average of the widths of the conductive patches and a path length that is at least three times longer than the average of the path lengths of the conductive patches.

30-34. (canceled)
